(19) United States
(12) Patent Application Publication
(10) Pub. No.: US 2012/0011078 A1
(43) Pub. Date: Jan. 12, 2012

(54) Developing Business Process Models That Are Aligned With Business Components And Business Intent

(75) Inventor: Harirajan Padmanabhan, Endicott, NY (US)

(73) Assignee: INTERNATIONAL BUSINESS MACHINES CORPORATION, ARMONK, NY (US)

(21) Appl. No.: 12/830,621

(22) Filed: Jul. 6, 2010

(51) Int. Cl. G06Q 10/00

(52) U.S. Cl. 705/348

(57) ABSTRACT

Methods, apparatus, and products for developing business process models that are aligned with business components and business intent, including: defining a plurality of business components, wherein each business component is a logical element of a business enterprise that carries out a particular business function; associating one or more activities with a particular business component, wherein each activity is identified by a unique identifier, and wherein each activity is an atomic operation carried out by the particular business component that the activity is associated with; and defining, in dependence upon the associated one or more activities, a business capability that is carried out by one or more business components.

### BACKGROUND OF THE INVENTION

1. Field of the Invention

The field of the invention is data processing, or, more specifically, methods, apparatus, and products for developing business process models that are aligned with business components and business intent.

2. Description of Related Art

Business intent is captured and expressed through business operational models. Business operational models are developed using a componentized view of a business enterprise, describing the various business components, business goals, objectives, metrics and interactions among the business components in order to depict how the business enterprise is expected to behave. Technologies have been developed to assist in the creation and maintenance of business operational models such as, for example, WebSphere Business Modeler developed by International Business Machines™.

### SUMMARY OF THE INVENTION

Methods, systems, and computer program products are provided for developing business process models that are aligned with business components and business intent. Embodiments include defining a plurality of business components, wherein each business component is a logical element of a business enterprise that carries out a particular business function. Embodiments also include associating one or more activities with a particular business component, wherein each activity is identified by a unique identifier, and wherein each activity is an atomic operation carried out by the particular business component that the activity is associated with. Embodiments further include defining, in dependence upon the associated one or more activities, a business capability that is carried out by one or more business components.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example of a business enterprise for which business process models are aligned with business components and business intent according to embodiments of the present invention.

FIG. 2 sets forth a block diagram of automated computing machinery comprising an exemplary computer useful in developing business process models that are aligned with business components and business intent according to embodiments of the present invention.

FIG. 3A sets forth a block diagram of an example of business components and associated activities useful in developing business process models that are aligned with business components and business intent according to embodiments of the present invention.

FIG. 3B sets forth a graphical representation of an example of business components and business capabilities useful in developing business process models that are aligned with business components and business intent according to embodiments of the present invention.

FIG. 3C sets forth a graphical representation of an example of business components and a business capability useful in developing business process models that are aligned with business components and business intent according to embodiments of the present invention.

FIG. 4 sets forth a graphical representation of business process models that are aligned with business components and business intent according to embodiments of the present invention.

FIG. 5 sets forth a flow chart illustrating an exemplary method for developing business process models that are aligned with business components and business intent according to embodiments of the present invention.

### DETAILED DESCRIPTION OF EXEMPLARY EMBODIMENTS

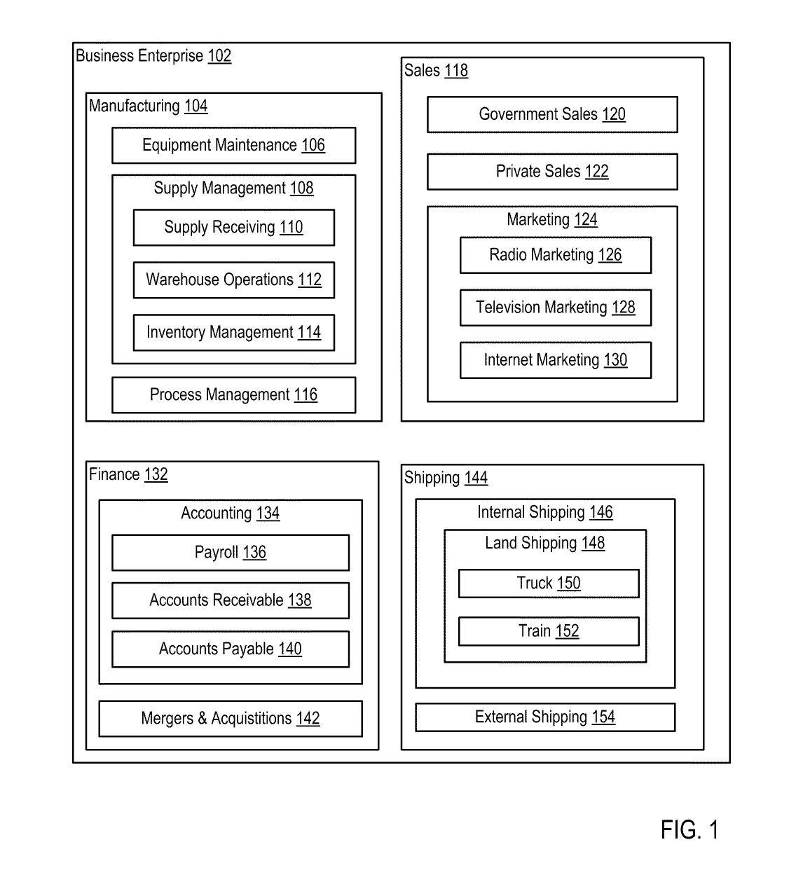

Exemplary methods, apparatus, and products for developing business process models that are aligned with business components and business intent in accordance with the present invention are described with reference to the accompanying drawings, beginning with FIG. 1. FIG. 1 sets forth a block diagram of an example of a business enterprise (102) for which business process models are aligned with business components and business intent according to embodiments of the present invention. In the example of FIG. 1, a business enterprise (102) is a representation of a business entity that provides goods, services, or both, to consumers. A business enterprise (102) may be embodied, for example, as a data structure, as a collection of computer program instructions such as object-oriented classes, or any combination thereof. A business enterprise (102) may be comprised of one or more special purpose business components that carry out business functions on behalf of the business enterprise (102).

In the example of FIG. 1, the business enterprise (102) includes a manufacturing business component (104), a sales business component (118), a finance business component (132), and a shipping business component (144). Each business component of the business enterprise (102) may include one or more sub-components, which are business components themselves. A business enterprise (102) and the business components therein may be componentized until the desired level of granularity for each business component is achieved.

In the example of FIG. 1, each business component carries out a particular business function on behalf of the business enterprise (102). The particular business function carried out by a particular business component may be expressed as one or more business activities, as described in greater detail below. The manufacturing business component (104) of FIG. 1, for example, may carry out all manufacturing related activities associated with a business enterprise (102) that manufactures goods for consumers. Likewise, the sales business component (118) may carry out all sales related activities associated with a business enterprise (102) such deploying sales personnel to different areas of a sales area, targeting potential consumers, and developing and advertising and marketing materials for goods or services offered for sale by the business enterprise (102).

In the example of FIG. 1, the manufacturing business component (104) includes an equipment maintenance business component (106), a process management business component (116), and a supply management business component (108) that includes a supply receiving business component (110), a warehouse operations business component (112), and an inventory management business component (114). These business components are included only for illustrative purposes and represent an example of a manufacturing department for a particular business enterprise (102). Each business component carries out a particular business function on behalf of the business enterprise (102). For example, the equipment maintenance business component (106) may carry out all activities related to maintaining equipment used in the manufacture of goods provided by the business enterprise (102) while the process management business component (116) carries out all activities related to developing and optimizing manufacturing processes used to manufacture goods provided by the business enterprise (102).

In the example of FIG. 1, the sales business component (118) includes a government sales business component (120), a private sales business component (122), and a marketing business component (124) that includes a radio marketing business component (126), a television marketing business component (128), and an internet marketing business component (130). In the example of FIG. 1, the finance business component (132) includes a mergers and acquisitions business component (142) and an accounting business component (134) that is made up of a payroll business component (136), an accounts receivable business component (138), and an accounts payable business component (140). In the example of FIG. 1, the shipping business component (144) includes an external shipping business component (154) and an internal shipping business component (146) with a land shipping business component (148) made up of a truck business component (150) and a train business component (152). These business components are included only for illustrative purposes and represent a hypothetical sales department, finance department, and shipping department for a particular business enterprise (102).

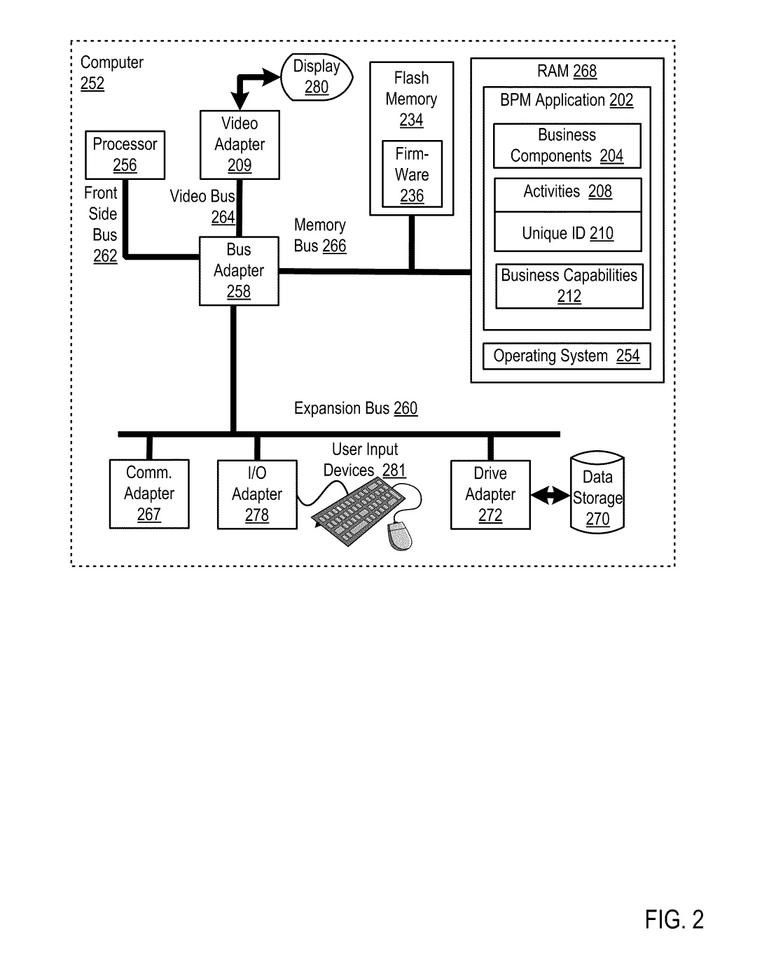

Developing business process models that are aligned with business components and business intent in accordance with the present invention is generally implemented with computers, that is, with automated computing machinery. For further explanation, therefore, FIG. 2 sets forth a block diagram of automated computing machinery comprising an exemplary computer (252) useful in developing business process models that are aligned with business components and business intent according to embodiments of the present invention. The computer (252) of FIG. 2 includes at least one computer processor (256) or ‘CPU’ as well as random access memory (268) (RAM') which is connected through a high speed memory bus (266) and bus adapter (258) to processor (256) and to other components of the computer (252).

Stored in RAM (268) is a business process model application (202), a module of computer program instructions for developing business process models that are aligned with business components and business intent. The business process model application (202) of FIG. 2 includes computer program instructions for defining a plurality of business components (204). In the example of FIG. 2, each business component (204) represents a logical element of a business enterprise that carries out a particular business function. Each business component (204) may represent, for example, a particular organization within a business enterprise, a particular business unit within a business enterprise, a particular team within a business enterprise, a particular role within a business enterprise, and so on. Each business function carried out by a particular business component represents a high-level operational aspect of a business enterprise that may be represented a series one or more atomic operations, referred to herein as activities (208). For example, a particular business enterprise may include a ‘shipping a product to a customer’ business function. Such a business function may be carried out by a business component (204), such as a shipping business component, and may be comprised of activities (208) such as locating a product in a warehouse, packing the product, addressing the package, delivering the product to a shipping mechanism such as a delivery truck, delivering the product to the address specified on the package, and so on.

In the example of FIG. 2, at least one business component (204) is a sub-component of another business component (204). Each business component (204) may have more than one sub-component and the sub-components of a particular business component (204) may exist at any level of depth. For example, the business enterprise depicted in FIG. 1 has a manufacturing business component, that includes a supply management sub-component, which itself has supply receiving, warehouse operations, and inventory management sub-components. Although only three hierarchical levels of components and sub-components are depicted, many additional hierarchical levels of components and sub-components may exist.

The business process model application (202) of FIG. 2 also includes computer program instructions for associating one or more activities (208) with a particular business component (204). Each activity (208) of FIG. 2 is an atomic operation carried out by the particular business component (204) that the activity (208) is associated with. Each activity (208) is atomic in the sense that the activity is indivisible and cannot be broken up into sub-activities. Activities (208) therefore represent the most granular level of business operations as an activity (208) cannot be deconstructed into sub-parts. Activities (208) may be associated with a particular business component (204), for example, using a table whose entries map a particular activity (208) to a particular business component (204), by including a component identifier with each activity (208), and so on. In the example of FIG. 2, each activity (208) is identified by a unique identifier (210). In the example of FIG. 2, each activity (208) is associated with one or more business components (204).

The business process model application (202) of FIG. 2 also includes computer program instructions for defining, in dependence upon the associated one or more activities (208), a business capability (212) that is carried out by one or more business components (204). A business capability (212) is a function carried out by a particular business enterprise that can be expressed as a plurality of activities (208). Because each activity (208) is carried out by a particular business component (204), each business capability (212) can be modeled as an interaction among many business components (204) that is expressed as a sequence of activities (208) that are carried out by the business components (204).

In the example of FIG. 2, the business capabilities (212) have defined inputs and outputs. The defined inputs may be embodied, for example, as data structures useful in performing a particular business capability. The defined outputs may be embodied, for example, as data structures useful in expressing the results from carrying out a particular business capability. Such data structures may include parameters, variables, links to other data sources, and so on.

The business process model application (202) of FIG. 2 also includes computer program instructions for defining a granular process model for the business capabilities (212). The granular process model of FIG. 2 includes a particular order of one or more activities (208). In the example of FIG. 2, each of the one or more activities (208) in the granular process model has defined inputs and outputs. The defined inputs may be embodied, for example, as data structures useful in performing a particular activity (208). The defined outputs may be embodied, for example, as data structures useful in expressing the results from carrying out a particular activity (208). In the example of FIG. 2, the outputs of a first activity (208) of the process model are the inputs of a next activity (208) of the process model. The output of the first activity (208) may be provided as inputs to a next activity (208), for example, by passing the output of the first activity (208) as a parameter of the next activity (208).

Also stored in RAM (268) is an operating system (254). Operating systems useful developing business process models that are aligned with business components and business intent according to embodiments of the present invention include UNIX™, Linux™, Microsoft XP™, AIX™, IBM's i5/OS™, and others as will occur to those of skill in the art. The operating system (254) and the business process model application (202) in the example of FIG. 2 are shown in RAM (268), but many components of such software typically are stored in non-volatile memory also, such as, for example, on a disk drive (270).

The computer (252) of FIG. 2 includes disk drive adapter (272) coupled through expansion bus (260) and bus adapter (258) to processor (256) and other components of the computer (252). Disk drive adapter (272) connects non-volatile data storage to the computer (252) in the form of disk drive (270). Disk drive adapters useful in computers for [preamble] according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (252) of FIG. 2 includes one or more input/output (‘I/O’) adapters (278). I/O adapters implement user-oriented input/output through, for example, software drivers and computer hardware for controlling output to display devices such as computer display screens, as well as user input from user input devices (281) such as keyboards and mice. The example computer (252) of FIG. 2 includes a video adapter (209), which is an example of an I/O adapter specially designed for graphic output to a display device (280) such as a display screen or computer monitor. Video adapter (209) is connected to processor (256) through a high speed video bus (264), bus adapter (258), and the front side bus (262), which is also a high speed bus.

The exemplary computer (252) of FIG. 2 includes a communications adapter (267) for data communications with other computers and for data communications with a data communications network. Such data communications may be carried out serially through RS-232 connections, through external buses such as a Universal Serial Bus (USW), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for developing business process models that are aligned with business components and business intent according to embodiments of the present invention include modems for wired dial-up communications, Ethernet (IEEE 802.3) adapters for wired data communications network communications, and 802.11 adapters for wireless data communications network communications.

Although FIG. 2 depicts only one embodiment of automated computing machinery for developing business process models that are aligned with business components and business intent in accordance with the present invention, other embodiments are contemplated. Developing business process models that are aligned with business components and business intent may be carried out, for example, in a distributed computing environment, cloud computing environment, or other computing environment.

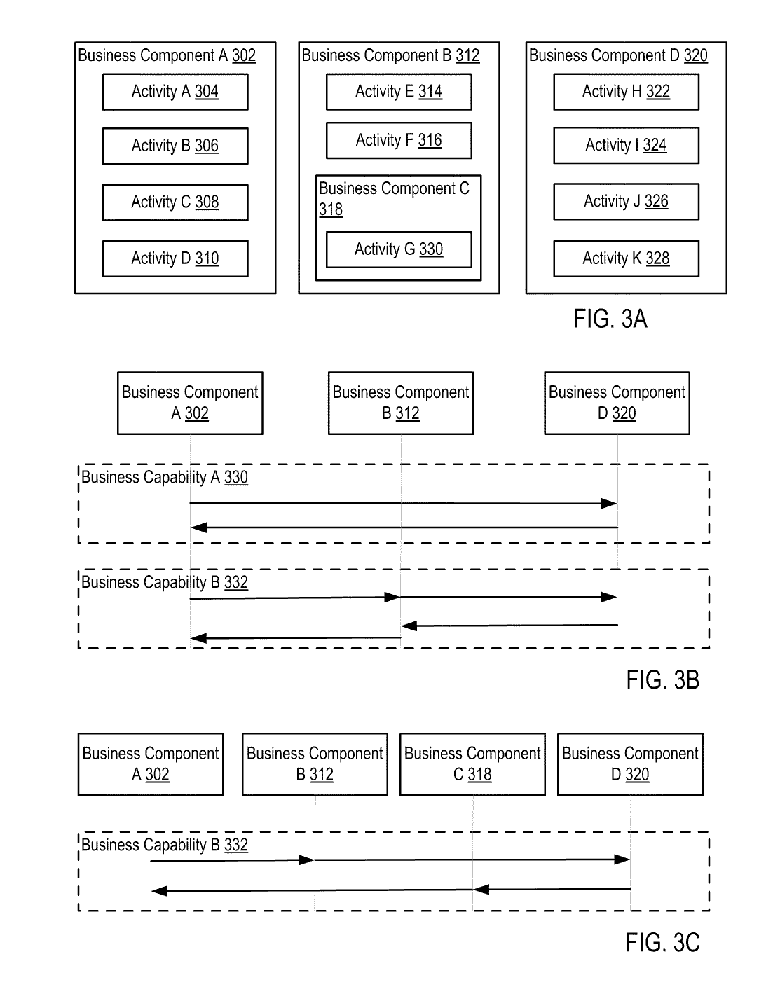

For further explanation, FIG. 3A sets forth a block diagram of an example of business components (302, 312, 318, 320) and associated activities (304, 306, 308, 310, 314, 316, 322, 324, 326, 328, 330) useful in developing business process models that are aligned with business components and business intent according to embodiments of the present invention. The example of FIG. 3A includes four business components: Business Component A (302), Business Component B (312), Business Component C (318), and Business Component D (320). In the example of FIG. 3A, Business Component C (318) is a sub-component of Business Component B (312).

In the example of FIG. 3A, each business component (302, 312, 318, 320) is associated with one or more activities For example, Business Component A (302) is associated with Activity A (304), Activity B (306), Activity C (308), and Activity D (310). Business Component B (312) is associated with Activity E (314) and Activity F (316). Business Component C (318) is associated with Activity G (330). Business Component D (320) is associated with Activity H (322), Activity I (324), Activity J (326), and Activity K (328). Each activity therefore includes a unique identifier and each activity is associated with at least one business component. Activities may be associated with more than one business component, however, when an activity is associated with a business component that is a sub-component of another business component. For example, in FIG. 3A Activity G (330) is associated with Business Component C (318). Because Business Component C (318) is a sub-component of Business Component B (312), Activity G (330) is therefore also associated with Business Component B (312). Thus, business component interaction diagrams can be drawn using the highest level business components or using any of the lower level business components with which the related activities are associated. This allows even complex interactions to be depicted as simple business component interactions if abstracted at appropriate higher levels. Furthermore, any business component interaction diagram can be drilled down to the appropriate detailed business component level as needed to describe a business capability more precisely at a detailed level.

For further explanation, FIG. 3B sets forth a graphical representation of an example of business components (302, 312, 320) and business capabilities (330, 332) useful in developing business process models that are aligned with business components and business intent according to embodiments of the present invention. The example of FIG. 3B includes graphical representations of two business capabilities: Business Capability A (330) and Business Capability B (332). In the example of FIG. 3B, the business capabilities (330, 332) are depicted as a series of actions taken by business components (302, 312, 320) introduced in FIG. 3A. Each business capability (330, 332) therefore represents functionality that can be carried out by a business enterprise, expressed as a series of actions taken by business components of such a business enterprise. For example, Business Capability A (330) begins with an action being taken by Business Component A (302), followed by an action being taken by Business Component D (320), which is followed by an action being taken by Business Component A (302).

In the example of FIG. 3B, Business Capability B (332) begins with an action being taken by Business Component A (302), followed by an action being taken by Business Component B (312), followed by an action being taken by Business Component D (320), followed by an action being taken by Business Component B (312), and followed by an action being taken by Business Component A (302). In the example of FIG. 3B, the disjoint between the lines illustrating the fourth and fifth actions, which occurs at the marker for Business Component B (312) is used to indicate that the target business component to perform the fourth action is a sub-component of Business Component B (312), which is Business Component C (318). In the example of FIG. 3B, each action carried out by a particular business component may correspond to a particular activity, such as any of the activities depicted in FIG. 3A, that is associated with the particular business component.

For further explanation, FIG. 3C sets forth a graphical representation of an example of business components (302, 312, 318, 320) and a business capability (332) useful in developing business process models that are aligned with business components and business intent according to embodiments of the present invention. In the example of FIG. 3C, Business Capability B (332) is depicted. In FIG. 3C, Business Capability B (332) begins with an action being taken by Business Component A (302), followed by an action being taken by Business Component B (312), followed by an action being taken by Business Component D (320), followed by an action being taken by Business Component C (318), and followed by an action being taken by Business Component A (302).

Business Capability B (332) in FIG. 3C is identical to Business Capability B (332) in FIG. 3B, however, Business Capability B (332) is depicted differently in each figure. Each depiction of Business Capability B (332) indicates that Business Capability B (332) begins with an action being taken by Business Component A (302), followed by an action being taken by Business Component B (312), followed by an action being taken by Business Component D (320). In FIG. 3B, the illustration of Business Capability B (332) indicates that a sub-component of Business Component B (312) takes the next action. In FIG. 3C, however, the illustration of Business Capability B (332) indicates that Business Component C (318) takes the next action. Because Business Component C (318) is a sub-component of Business Component B (312), each illustration indicates that the fourth action taken to carry out Business Capability B (332) is taken by Business Component C (318). As such, FIGS. 3B and 3C illustrate identical sequence of actions being taken by a plurality of business components (302, 312, 318, 320) utilizing different representations of the same business capability (332). Thus, business component interaction diagrams can be drawn using the highest level business components or using any of the lower level business components with which the related activities are associated. This allows even complex interactions to be depicted as simple business component interactions if abstracted at appropriate higher levels

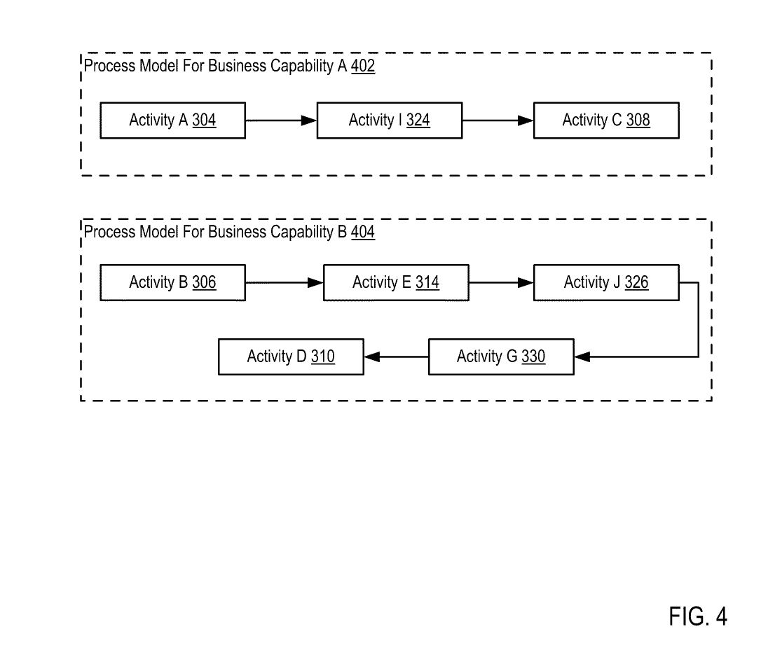

For further explanation, FIG. 4 sets forth a graphical representation of business process models (402, 404) that are aligned with business components and business intent according to embodiments of the present invention. The example of FIG. 4 includes a graphical representation of the process model (402) for Business Capability A, which was introduced above with reference to FIG. 3B. The example of FIG. 4, also includes a graphical representation of the process model (404) for Business Capability B, which was also introduced above with reference to FIG. 3B and FIG. 3C. In the example of FIG. 4, the process model (402) for Business Capability A includes carrying out Activity A (304), followed by carrying out Activity I (324), which is followed by carrying out Activity C (308). Each of the activities (304, 324, 308) of the process model (402) for Business Capability A were introduced above with reference to FIG. 3A. Activity A (304) was associated with Business Component A (302), Activity I (324) was associated with Business Component D (320), and Activity C (308) was associated with Business Component A (302). As such, readers will recognize that the process model (402) for Business Capability A is carried out by activities (304, 324, 308) that are associated with business components such that the series of activities (304, 324, 308) correspond to the order in which business components carry out actions to carry out Business Capability A (330 in FIG. 3B) as described above with reference to FIG. 3B. In the example of FIG. 4, the process model (402) for Business Capability A is therefore an expression of Business Capability A as a collection of activities that is entirely consistent with the expression of Business Capability A as a series of actions taken by business components depicted in FIG. 3B.

In the example of FIG. 4, the process model (404) for Business Capability B includes carrying out Activity B (306), followed by carrying out Activity E (314), followed by carrying out Activity J (326), followed by carrying out Activity G (318), which is followed by carrying out Activity D (310). Each of the activities (306, 310, 314, 318, 326) of the process model (404) for Business Capability B were introduced above with reference to FIG. 3A. Activity B (306) was associated with Business Component A (302), Activity E (314) was associated with Business Component B (312), Activity J (326) was associated with Business Component D (320), Activity G (318) was associated with Business Component C (318), and Activity D (310) was associated with Business Component A (310). As such, readers will recognize that the process model (404) for Business Capability B is carried out by activities (306, 310, 314, 318, 326) that are associated with business components such that the series of activities (306, 310, 314, 318, 326) correspond to the order in which business components carry out actions to carry out Business Capability B (332 in FIG. 3B and FIG. 3C) as described above with reference to FIG. 3B and FIG. 3C. In the example of FIG. 4, the process model (404) for Business Capability B is therefore an expression of Business Capability B as a collection of activities that is entirely consistent with the expression of Business Capability B as a series of actions taken by business components depicted in FIG. 3B and FIG. 3C. The process models (402, 404) of FIG. 4 are depicted as a series of activities. Such process models (402, 404) may be developed using decision and branching logic to apply business rules in selecting an including activities that form a particular process model.

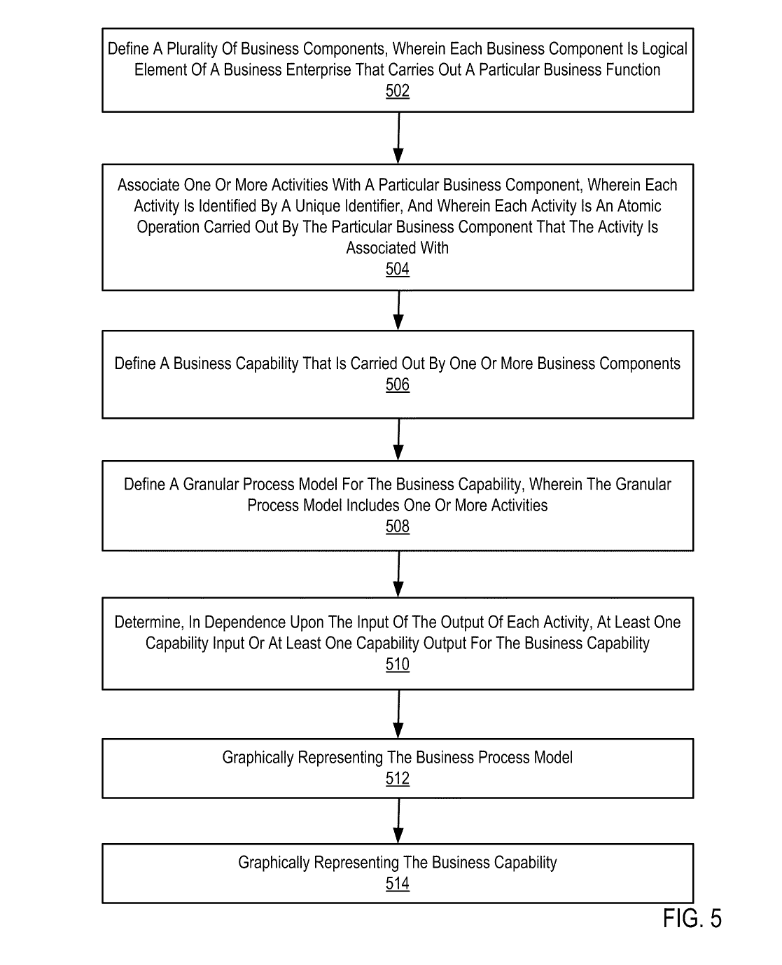

For further explanation, FIG. 5 sets forth a flow chart illustrating an exemplary method for developing business process models that are aligned with business components and business intent according to embodiments of the present invention that includes defining (502) a plurality of business components. In the example of FIG. 5, each business component is a logical element of a business enterprise that carries out a particular business function. Each business component may be, for example, a particular organization within a business enterprise, a particular business unit within a business enterprise, a particular team within a business enterprise, a particular role within a business enterprise, and so on. Each business function carried out by a particular business component represents a high-level operational aspect of a business enterprise that may be represented a series one or more atomic operations, referred to herein as activities. For example, a particular business enterprise may include a ‘shipping a product to a customer’ business function. Such a business function may be carried out by a business component, such as a shipping business component, and may be comprised of activities such as locating a product in a warehouse, packing the product, addressing the package, delivering the product to a shipping mechanism such as a delivery truck, delivering the product to the address specified on the package, and so on.

In the example of FIG. 5, at least one business component is a sub-component of another business component. Each business component may have more than one sub-component and the sub-components of a particular business component may exist at any level of depth. For example, the business enterprise depicted in FIG. 1 has a manufacturing business component, that includes a supply management sub-component, which itself has supply receiving, warehouse operations, and inventory management sub-components. Readers will appreciate that although only three levels of depth are depicted, sub-components may be nested at much deeper layers of depth.

The example of FIG. 5 also includes associating (504) one or more activities with a particular business component. Each activity in the example of FIG. 5 is an atomic operation carried out by the particular business component that the activity is associated with. Activities therefore represent the most granular level of business activity as an activity cannot be deconstructed into sub-parts. Activities may be associated with a particular business component, for example, using a table whose entries map a particular activity to a particular business component, by including a component identifier with each activity, and so on. In the example of FIG. 5, each activity is identified by a unique identifier. In the example of FIG. 5, each activity is associated with at least one business component. In the example of FIG. 5, each activity that is associated with a sub-component of a particular business component is also associated with the particular business component.

The example of FIG. 5 also includes defining (506), in dependence upon the associated one or more activities, a business capability that is carried out by one or more business components. A business capability is a function carried out by a particular business enterprise that can be expressed as a plurality of activities. Because each activity is carried out by a particular business component, each business capability can be modeled as an interaction among many business components expressed as a sequence of activities that are carried out by the business components.

In the example of FIG. 5, the business capability has defined inputs and outputs. The defined inputs may be embodied, for example, as data structures useful in performing a particular business capability. The defined outputs may be embodied, for example, as data structures useful in expressing the results from carrying out a particular business capability.

The example of FIG. 5 also includes defining (508) a granular process model for the business capability. The granular process model of FIG. 5 includes a particular order of one or more activities. In the example of FIG. 5, each of the one or more activities in the granular process model has defined inputs and outputs. The defined inputs may be embodied, for example, as data structures useful in performing a particular activity. The defined outputs may be embodied, for example, as data structures useful in expressing the results from carrying out a particular activity. In the example of FIG. 5, the outputs of a first activity of the process model are the inputs of a next activity of the process model. The output of the first activity may be provided as inputs to a next activity, for example, by passing the output of the first activity as a parameter of the next activity.

The example of FIG. 5 also includes graphically (512) representing the business process model. Graphically (512) representing the business process model may be carried out, for example, by developing a graphical representations of each activity that is included in a particular business process and displaying the graphical representations of each activity so as to identify an order in which the activities are performed to carry out a particular business process, as described above with reference to FIG. 4. Graphical representations of the activities may be embodied, for example, as icons, images, or other rendering components.

The example of FIG. 5 also includes graphically (514) representing the business capability. Graphically (514) representing the business capability may be carried out, for example, by developing a graphical representations of each business component that carries out a particular business capability and displaying the graphical representations of each business component so as to identify an order in which the business components carry out activities to implement a particular business capability, as described above with reference to FIG. 3B. Graphical representations of each business component may be embodied, for example, as icons, images, or other rendering components.

In the example of FIG. 5, each business component may include an operational goal. Operational goals may be expressed in terms any quantifiable aspect of a particular business component's operations such as, for example, a number of units shipped, an amount of time required to manufacture a particular item, and average time frame for order processing, and so on. In the example of FIG. 5, each business component may also include a key performance indicator. The key performance indicator is a measured aspect of a particular business component's operations that may be used, for example, to determine whether a particular business component is meeting its operational goals.

Exemplary embodiments of the present invention are described in terms of implementing business capabilities by carrying out activities associated with business components, and modeling such business capabilities. The present invention may also be used to convert existing process models to business process models that are aligned with business components and business intent. Existing process models that are composed of a series of tasks may be converted to business process models that are aligned with business components and business intent by, for example, defining a plurality of business components, defining an activity to carry out one or more of the tasks performed by the existing process model, associating one or more activities with a particular business component, and defining, in dependence upon the associated one or more activities, a business capability that is carried out by one or more business components.

Exemplary embodiments of the present invention are described largely in the context of a fully functional computer system for developing business process models that are aligned with business components and business intent. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of developing a business process model that is aligned with business components and business intent, the method implemented in a computer that includes a computer processor, the method comprising:
defining a plurality of business components, wherein each business component is a logical element of a business enterprise that carries out a particular business function;
associating one or more activities with a particular business component, wherein each activity is identified by a unique identifier, and wherein each activity is an atomic operation carried out by the particular business component that the activity is associated with; and
defining, in dependence upon the associated one or more activities, a business capability that is carried out by one or more business components.

2. The method of claim 1 further comprising graphically representing the business process model.

3. The method of claim 1 further comprising graphically representing the business capability.

4. The method of claim 1 wherein:
at least one business component is a sub-component of another business component; and
the method further comprises associating, with a particular business component, each activity that is associated with each sub-component of the particular business component.

5. The method of claim 1 wherein the business capability has defined inputs and outputs.

6. The method of claim 1 further comprising defining a granular process model for the business capability, wherein the granular process model includes a particular order of one or more activities.

7. The method of claim 6 wherein each of the one or more activities in the granular process model have defined inputs and outputs.

8. The method of claim 7 wherein the outputs of a first activity of the process model are the inputs of a next activity of the process model.

9. Apparatus for developing business process models that are aligned with business components and business intent, the apparatus comprising a computer processor, a computer memory operatively coupled to the computer processor, the computer memory having disposed within it computer program instructions for:
defining a plurality of business components, wherein each business component is a logical element of a business enterprise that carries out a particular business function;
associating one or more activities with a particular business component, wherein each activity is identified by a unique identifier, and wherein each activity is an atomic operation carried out by the particular business component that the activity is associated with; and
defining in dependence upon the associated one or more activities a business capability that is carried out by one or more business components.

10. The apparatus of claim 9 further comprising computer program instructions for graphically representing the business process model.

11. The apparatus of claim 9 further comprising computer program instructions for graphically representing the business capability.

12. The apparatus of claim 9 wherein:
at least one business component is a sub-component of another business component; and
the apparatus further includes computer program instructions for associating, with a particular business component, each activity that is associated with each sub-component of the particular business component.

13. The apparatus of claim 9 wherein the business capability has defined inputs and outputs.

14. The apparatus of claim 9 further comprising computer program instructions for defining a granular process model for the business capability, wherein the granular process model includes a particular order of one or more activities.

15. The apparatus of claim 14 wherein each of the one or more activities in the granular process model have defined inputs and outputs.

16. The apparatus of claim 15 wherein the outputs of a first activity of the process model are the inputs of a next activity of the process model.

17. A computer program product for developing business process models that are aligned with business components and business intent, the computer program product disposed upon a computer readable storage medium, the computer program product comprising computer program instructions that, when executed, cause a computer to carry out the steps of:
defining a plurality of business components, wherein each business component is a logical element of a business enterprise that carries out a particular business function;
associating one or more activities with a particular business component, wherein each activity is identified by a unique identifier, and wherein each activity is an atomic operation carried out by the particular business component that the activity is associated with; and
defining in dependence upon the associated one or more activities a business capability that is carried out by one or more business components.

18. The computer program product of claim 17 further comprising computer program instructions for graphically representing the business process model.

19. The computer program product of claim 17 further comprising computer program instructions for graphically representing the business capability.

20. The computer program product of claim 17 wherein:
at least one business component is a sub-component of another business component; and
the computer program product further includes computer program instructions for associating, with a particular business component, each activity that is associated with each sub-component of the particular business component.

21. The computer program product of claim 17 wherein the business capability has defined inputs and outputs.

22. The computer program product of claim 17 further comprising computer program instructions that, when executed, cause the computer to carry out the step of defining a granular process model for the business capability, wherein the granular process model includes a particular order of one or more activities.

23. The computer program product of claim 22 wherein each of the one or more activities in the granular process model have defined inputs and outputs.

24. The computer program product of claim 23 wherein the outputs of a first activity of the process model are the inputs of a next activity of the process model.
